(19) United States
(12) Patent Application Publication
(10) Pub. No.: US 2026/0152336 A1
(43) Pub. Date: Jun. 4, 2026

(54) CARRIER FOR CONTAINERS

(71) Applicant: Graphic Packaging International, LLC, Atlanta, GA (US)

(72) Inventor: Scott Cockle, Bristol (GB)

(21) Appl. No.: 19/399,729

(22) Filed: Nov. 25, 2025

Related U.S. Application Data
(60) Provisional application No. 63/727,290, filed on Dec. 3, 2024.

(51) Int. Cl. B65D 71/44; B31D 5/04

(52) U.S. Cl. CPC B65D 71/44; B31D 5/04; B65D 2571/00469; B65D 2571/0066; B65D 2571/00802

(57) ABSTRACT

A carrier for at least partially holding a plurality of containers arranged with one or more containers in at least a first row and one or more containers in a second row. The carrier can comprise a keel foldably connected to a handle. The keel can be for being positioned between the first row and the second row and can comprise a central panel attached to one or more containers in the second row. The handle can comprise a handle panel foldably connected to the central panel. The handle can be movable between a lowered position with the handle panel extending at least partially over at least one of the first row and the second row and a carrying position with the handle panel extending at least upwardly from the keel.

### CROSS-REFERENCE TO RELATED APPLICATIONS

The present application claims priority to U.S. Provisional Patent Application No. 63/727,290, filed on Dec. 3, 2024, entitled Carrier for Containers.

### INCORPORATION BY REFERENCE

The disclosure of U.S. Provisional Patent Application No. 63/727,290, filed on Dec. 3, 2024, entitled Carrier for Containers, is hereby incorporated by reference herein as if set forth in its entirety.

### BACKGROUND OF THE DISCLOSURE

The present disclosure generally relates to carriers for holding, displaying, and/or transporting beverage containers or other types of articles.

### SUMMARY OF THE DISCLOSURE

In general, one aspect of the disclosure is directed to a carrier for holding a plurality of containers, the carrier comprising a front central panel, a back central panel foldably connected to the front central panel, the front central panel and the back central panel for being attached to at least one container of the plurality of containers. The carrier has handle features foldably connected to the front central panel and the back central panel, the handle features comprising a front handle panel foldably connected to the front central panel and a back handle panel foldably connected to the back central panel. The front handle panel and the back handle panel form a handle of the carrier. The front central panel comprises at least one front glue opening and the back central panel comprises at least one back glue opening.

In another aspect, the disclosure is directed to a blank for holding a plurality of containers, the blank comprising a front central panel, a back central panel foldably connected to the front central panel, the front central panel and the back central panel are for being attached to at least one container of the plurality of containers in the carrier formed from the blank. The blank has handle features foldably connected to the front central panel and the back central panel, the handle features comprising a front handle panel foldably connected to the front central panel and a back handle panel foldably connected to the back central panel. The front handle panel and the back handle panel are for forming a handle of the carrier formed from the blank. The front central panel comprises at least one front glue opening and the back central panel comprises at least one back glue opening.

In another aspect, the disclosure is generally directed to a method of forming carrier for holding a plurality of containers. The method comprises obtaining a blank comprising a front central panel, a back central panel foldably connected to the front central panel, the front central panel comprises at least one front glue opening and the back central panel comprises at least one back glue opening. The blank includes handle features foldably connected to the front central panel and the back central panel, the handle features comprising a front handle panel foldably connected to the front central panel and a back handle panel foldably connected to the back central panel. The method includes attaching the front central panel and the back central panel to at least one container of the plurality of containers and forming a handle from the front handle panel and the back handle panel.

In another aspect, the disclosure is generally directed to a package comprising a carrier at least partially holding a plurality of articles.

In another aspect, the disclosure is directed to a method of forming a package.

Other aspects, features, and details of the present disclosure can be more completely understood by reference to the following detailed description of exemplary embodiments taken in conjunction with the drawings and from the appended claims.

Those skilled in the art will appreciate the above stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of a blank used to form a carrier according to a first exemplary embodiment of the disclosure.

FIG. 2 is a perspective view of a package including a carrier formed from the blank of FIG. 1 and a plurality of containers held by the carrier.

FIG. 3 is a perspective view of the package of FIG. 2 with a pair of containers removed.

FIG. 4 is a schematic end view of an enlarged portion of the package of FIGS. 2 and 3 schematically showing the attachment of the carrier to the containers with glue according to the exemplary embodiments.

FIG. 5 is a perspective view of the package of FIGS. 2 and 3 with a handle of the carrier in a carrying position according to the exemplary embodiments.

FIG. 5A is an enlarged portion of FIG. 5.

FIG. 6 is a plan view of a blank used to form a carrier according to a second exemplary embodiments of the disclosure.

FIGS. 7A-7E are perspective views showing the forming of the blank of FIG. 6 into a carrier and attaching the carrier to a plurality of containers/articles to form a package according to the second embodiments of the disclosure.

FIG. 8 is a perspective view of the package of FIG. 7E according to the second exemplary embodiments.

FIGS. 9A and 9B are perspective views of the package of FIGS. 7E and 8 with a handle of the carrier in a carrying position according to the second exemplary embodiments.

Corresponding parts are designated by corresponding reference numbers throughout the drawings.

### DETAILED DESCRIPTION OF THE EXEMPLARY EMBODIMENTS

The present disclosure generally relates to various features for cartons, sleeves, wraps, and/or carriers that contain articles such as containers, bottles, jars, cans, etc. The articles can be used for packaging beverage and/or food products, for example. The articles can be made from materials suitable in composition for packaging the particular beverage or food item, and the materials include, but are not limited to, paper products, such as coated, lined, and/or laminated paperboard; plastics such as PET, LDPE, LLDPE, HDPE, PP, PS, PVC, EVOH, and Nylon; glass; aluminum and/or other metals; and the like, or any combination thereof.

Cartons or carriers according to the present disclosure can accommodate articles of any shape. For the purpose of illustration and not for the purpose of limiting the scope of the disclosure, the following detailed description describes beverage and/or food containers (e.g., paperboard cartons for beverages and/or other liquids and/or other materials, aseptic packages, such as, but not limited to, aseptic packaging available from Tetra Pak International S.A., and/or other suitable packaging) as disposed within the carrier embodiments. In this specification, the terms “inner,” “interior,” “outer,” “exterior,” “lower,” “bottom,” “upper,” and “top” indicate orientations determined in relation to fully erected and upright cartons. As described herein, constructs can be formed with multiple walls, panels, portions, tabs, flaps, fold lines, and/or other aspects, which may be designated herein in terms relative to one another, e.g., “first,” “second,” “third,” etc., in sequential or nonsequential reference, without departing from the disclosure.

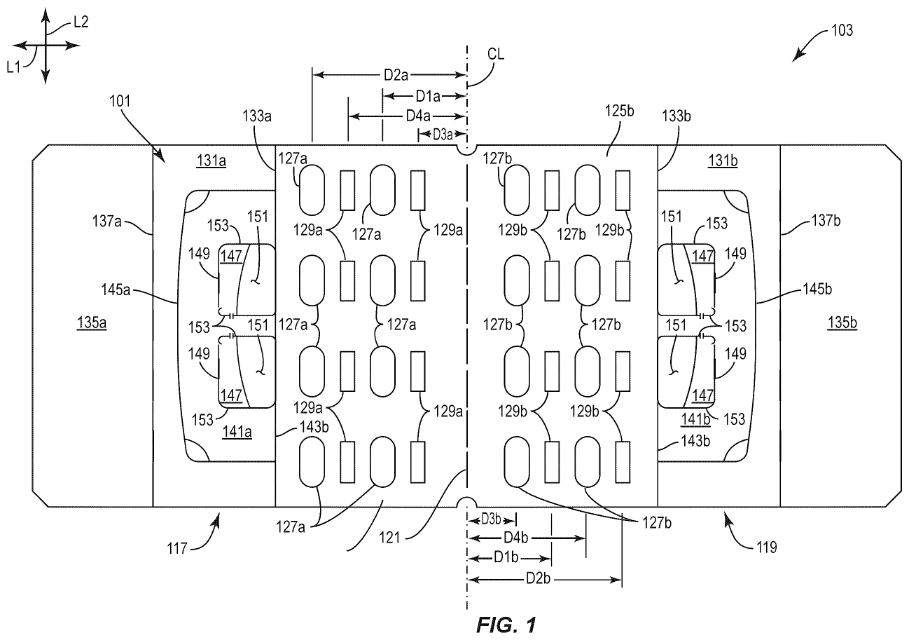

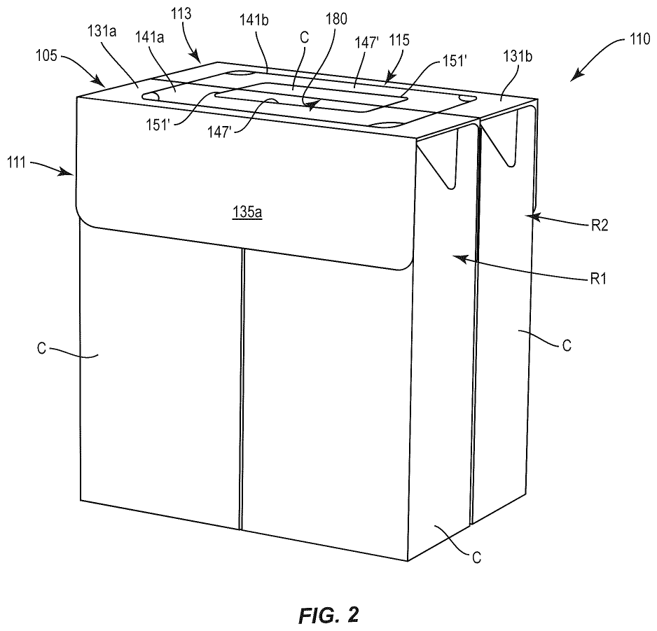

FIG. 1 shows a plan view of an exterior side 101 of a blank 103 used to form a carrier 105 (FIGS. 2-5A) in accordance with a first exemplary embodiment of the disclosure. The carrier 105 can be provided together with one or more containers C as a package 110 (FIGS. 2-5A). In the illustrated embodiments, the containers C are beverage cartons or other suitable containers (e.g., bottles, cans, food containers, etc.). The carrier 105 can be sized to house four containers C in a single layer in a 2×2 arrangement, but it is understood that the carrier 105 may be sized and shaped to hold containers of a different or same quantity in more than one layer and/or in different row/column arrangements, e.g., 1×6, 2×4, 2×6, 3×2, 3×4, 4×6, 3×8, 2×6×2, 3×4×2, 2×9, 3×6, etc.), or just a single article. In the illustrated embodiments, the containers C can be at least partially retained by the carrier 105 in two rows R1, R2 in the package 110. In embodiments, the first row R1 can extend along/in a first/front portion 111 of the carrier 105 and the second row R2 can extend along/in a second/back portion 113 of the carrier 105. As shown in FIG. 1, the blank 103 can include handle features for forming a handle 115 (FIGS. 2-5A) for grasping and/or carrying the package 110.

As shown in FIG. 1, the blank 101 has a longitudinal axis L1 and a lateral axis L2. The blank 101 has a first/front side 117 for forming the first/front portion 111 of the carrier 105, and a second/back side 119 for forming the second/back portion 113 of the carrier 105. In the illustrated embodiments, the first side 117 and the second side 119 of the blank 101 can be foldably connected along a lateral fold line 121 that can form a lateral centerline CL of the blank 101. In the illustrated embodiments, the first side 117 of the blank 103 comprises a first/front central panel 125a having a plurality of adhesive or glue openings 127a at interior portions thereof and a plurality of surface features or areas 129a adjacent the respective glue openings 127a. As shown in FIG. 1, the surface areas 129a are schematically represented by rectangles that indicate the respective locations of the surface areas 129a, which may not be physically defined or visibly indicated by features or markings on the actual blank. In alternative embodiments, the surface features 129a can be, for example, an embossed feature or other at least partially raised or recessed surface configuration.

In the illustrated embodiment, a first/front top panel 131a is foldably connected to the first/front central panel 125a along a lateral fold line 133a, and a first/front panel 135a is foldably connected to the first top panel 131a along a lateral fold line 137a. In alternative embodiments, the first top panel 131a can engage and/or can be secured to the tops of the containers C in the first row R1.

In the illustrated embodiment, the second/back side 119 of the blank 101 includes a second/back central panel 125b, a second/back top panel 131b, and a second/back panel 135b having associated features that are generally a mirror-image of the corresponding panels and flaps of the first side 117 of the blank 101. Corresponding components (e.g., panels, flaps, fold lines, cuts, etc.) have been designated by corresponding reference numbers that differ by the “a” or “b” suffix, with the “a” components corresponding to the first side 117 of the blank 101 and the “b” components corresponding to the second side 119 of the blank 101. In embodiments, the central panels 125a, 125b can cooperate to at least partially form a keel portion of the blank 103.

In the illustrated embodiments, the handle features can include a first/front handle panel 141a extending in the first/front side 117 and a second/back handle panel 141b extending in the second side 119. As shown in FIG. 1, the front handle panel 141a can be foldably connected to the front central panel 125a along a lateral fold line 143a, which can be collinear with the lateral fold line 133a, and the back handle panel 141b can be foldably connected to the back central panel 125b along a lateral fold line 143b, which can be collinear with the lateral fold line 133b. Further, the front handle panel 141a can be separable from the front top panel 131a along a tear or cut line 145a (e.g., a U-shaped cut line), and the back handle panel 141b can be separable from the back top panel 131b along a tear or cut line 145b (e.g., a U-shaped cut line). In exemplary embodiments, the handle panels 141a, 141b can be held in place (e.g., coplanar with the respective top panels 131a, 131b) by one or more breakable nicks (e.g., interrupting the cut lines 145a, 145b) or other suitable features until the handle 115 is actuated, folding the handle panels upwardly along the respective lateral fold lines 133a, 133b, which can break the nicks.

As shown in FIG. 1, the handle features can include two handle flaps or comfort flaps 147 foldably connected to each of the handle panels 141a, 141b along respective lateral fold lines 149. In embodiments, each of the handle flaps 147 can extend along a respective handle opening 151 and can be separable from the respective handle panels 141a, 141b along cut lines 153. In exemplary embodiments, the handle flaps 147 can be connected to the respective handle panel 141a, 141b by breakable nicks (e.g., interrupting one or more of the cut lines 153) or other suitable features, which can hold the handle flaps in place until the handle flaps 147 are actuated/folded along the respective fold lines 149 such as when gripping the handle 115. As shown in FIG. 1, edges of the central panels 125a, 125b can extend along the handle openings 151, and cutouts can be formed in the corners of the handle panels 141a, 141b that are spaced from the respective fold lines 143a, 143b.

Any of the handle panels 131a, 131b, the handle flaps 147, the handle openings 151, and/or other handle features could be omitted or could be otherwise configured, positioned, shaped, and/or arranged without departing from the disclosure. For example, the handle features could include any suitable number of handle flaps 147 and/or handle openings 151 (e.g., one or more handle flaps and/or handle openings).

As shown in FIG. 1, the glue openings 127a can be arranged in two rows in the front central panel 125a and the surface areas 129a are arranged in two rows in the front central panel 125a so that the glue openings 127a and the surface areas 129a are arranged in alternating rows. In the illustrated embodiments, the inner/lower row of glue openings 127a is spaced in the longitudinal direction L1 from the centerline CL (from the central fold line 121) by a distance D1a, the outer/upper row of glue openings 127a is spaced from the centerline CL/fold line 121 by a distance D2a, the inner/lower row of surface areas 129a is spaced from the centerline CL/fold line 121 by a distance D3a, and the outer/upper row of surface areas 129a is spaced from the centerline CL/fold line 121 by a distance D4a. Similarly, the glue openings 127b are arranged in two rows in the back central panel 125b and the surface areas 129b are arranged in two rows in the back central panel 125b so that the glue openings 127b and the surface areas 129b are arranged in alternating rows. In the illustrated embodiments, the inner/lower row of glue openings 127b is spaced from the centerline CL (from the central fold line 121) by a distance D3b, the outer/upper row of glue openings 127b is spaced from the centerline CL/fold line 121 by a distance D4b, the inner/lower row of surface areas 129b is spaced from the centerline CL/fold line 121 by a distance D1b, and the outer/upper row of surface areas 129b is spaced from the centerline CL/fold line 121 by a distance D2b.

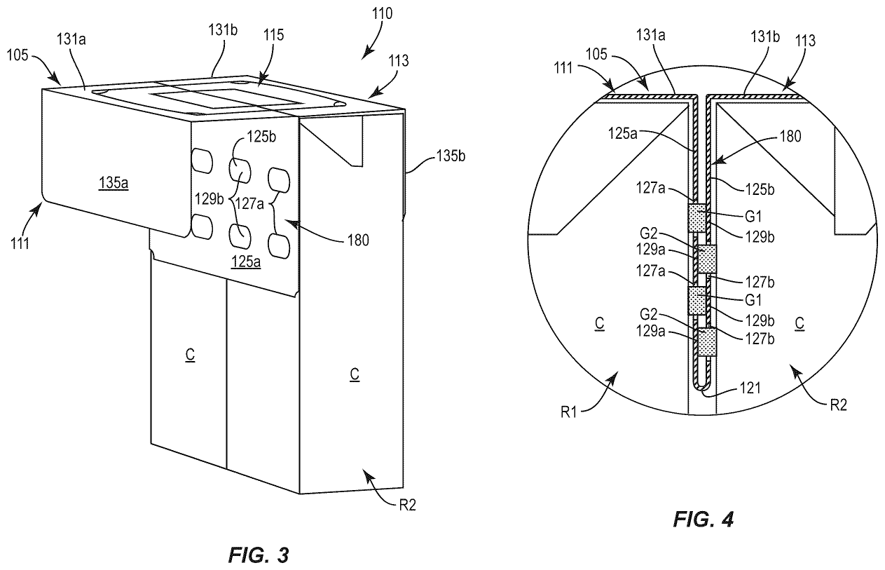

In the illustrated embodiments, the distance D1a and the distance D1b are similar or equal (e.g., approximately equal) so that the lower row of glue openings 127a in the front central panel 125a is at least partially aligned with the lower row of surface areas 129b in the back central panel 125b when the central panels 125a, 125b are folded along the lateral fold line 121 into face-to-face contact with one another (e.g., as shown in FIGS. 3 and 4). Further, the distance D2a and the distance D2b are similar or equal, the distance D3a and the distance D3b are similar or equal, and the distance D4a and the distance D4b are similar or equal so that the upper row of glue openings 127a in the front central panel 125a is at least partially aligned with the upper row of surface areas 129b in the back central panel 125b, so that the lower row of glue openings 127b in the back central panel 125b is at least partially aligned with the lower row of surface areas 129a in the front central panel 125a, and so that the upper row of glue openings 127b in the back central panel 125b is at least partially aligned with the upper row of surface areas 129a in the front central panel 125a when the central panels 125a, 125b are folded into face-to-face contact with one another (FIGS. 3 and 4).

Any of the glue openings 127a, 127b and/or the surface areas 129a, 129b could be omitted or could be otherwise configured, positioned, shaped, and/or arranged without departing from the disclosure. For example, the glue openings 127a, 127b and/or the surface areas 129a, 129b could be arranged in any suitable number or rows with any suitable number of glue openings 127a, 127b and/or surface areas 129a, 129b.

The blank 103 could be otherwise shaped and/or sized without departing from the disclosure. Further, any of the panels, flaps, fold lines, cuts, and/or other features of the blank 103 could be omitted or could be otherwise configured, positioned, shaped, and/or arranged, without departing from the disclosure.

In the illustrated embodiments, glue can be applied to the exterior surface 101 of the blank 103 along one or more portions of the central panels 125a, 125b, e.g., at least on the surface areas 129a, 129b. For example, the glue can be applied in glue strips and/or beads of glue (not shown) that can be at least partially aligned with the surface areas 129a, 129b on the respective central panels 125a, 125b. In embodiments, the glue can be applied in lateral strips that extend at least partially across the blank 103. In exemplary embodiments, the glue can be applied only in the surface areas 129a, 129b or can be applied so that the glue also extends on the central panels 125a, 125b outside of the surface areas 129a, 129b. In embodiments, glue also can be applied to portions of the central panels 129a, 129b in strips, beads, and/or other suitable configurations that are not aligned with the surface features 129a, 129b (e.g., for glueing the central panels 125a, 125b to one another when they are folded into face-to-face contact with one another).

In exemplary embodiments, glue also can be applied to the interior surfaces of one or more of the top panels 131a, 131b and the front and back panels 135a, 135b and/or to the tops and/or sides of the containers C before or during the formation of the package 110 from the blank 103 for securing the top panels 131a, 131b and/or the front and back panels 135a, 135b to the containers C when the package 110 is formed. Glue could be otherwise applied to the blank 103 and/or the partially formed carrier 105 without departing from the disclosure and/or the carrier 105 could be otherwise secured to the containers C without departing from the disclosure.

In the illustrated embodiments, the carrier 105 and the package 110 can be formed by placing the blank 103 over the containers C (e.g., moving on a conveyor in two streams, not shown) so that the front top panel 131a extends over the containers C in the first/front row R1 and the back top panel 131b extends over the containers C in the second/back row R2. The top panels 131a, 131b can be pressed down on the tops of the containers C in the respective rows R1, R2 (e.g., gluing the top panels to the tops of the containers in some embodiments), and the front and back panels 135a, 135b can be folded downwardly along the respective fold lines 137a, 137b and can be pressed against the sides of the containers C in the respective rows R1, R2 (e.g., gluing the side panels to the sides of the containers in some embodiments).

In addition, the rows R1, R2 of the containers C can be moved toward one another (e.g., while moving in a downstream direction of a conveyor) along with the top panels 131a, 131b while folding the central panels 125a, 125b (the keel portion of the blank 103) downwardly relative to the top panels 131a, 131b along the fold lines 143a, 143b, 121. As the central panels 125a, 125b fold downwardly, their exterior surfaces can move closer together and the central panels 125a, 125b can move into the space between the rows R1, R2 of the containers C. In exemplary embodiments, the containers C can be moved together until the exterior surfaces of the central panels 125a, 125b are moved into face-to-face contact with one another, the containers C in the first/front row R1 contact the interior surface of the front central panel 125a, and the containers C in the second/back row R2 contact the interior surface of the back central panel 125b.

As shown in FIGS. 2-4, when the central panels 125a, 125b are brought into at least partial face-to-face contact, the respective glue openings 127a, 127b in the respective central panels 125a, 125b are positioned so as to be laterally aligned but longitudinally offset due to the different relative spacing of the respective glue openings 127a, 127b away from the centerline CL. In this regard, the central panels 125a, 125b are arranged such that a portion of the front central panel 125a overlaps each of the glue openings 127b and a portion of the back central panel 125b overlaps each of the glue openings 127a to provide communication between the central panels 125a, 125b and respective surfaces upon which the respective containers C can be adhered or otherwise attached, as described further herein. As shown in FIGS. 2-4, when the central panels 125a, 125b are folded, brought into face-to-face contact, and adhered to the containers C in the respective rows R2, R1, the central panels 125a, 125b generally can form a keel 180 extending between the rows of the containers.

Referring to FIG. 3, in which the containers C in the front row R1 are removed for clarity of illustration, glue can be at least partially aligned with the glue openings 127a to adhere the containers C in the first row R1 to respective exposed portions of the central panel 125b through the respective glue openings 127a. Similarly, the glue can be at least partially aligned with the respective glue openings 127b to adhere the containers C in the back row R2 to respective exposed portions of the central panel 125a through the respective glue openings 127b. For example, the surface areas 129a in the lower row of surface areas on the front central panel 125a can extend along/at least partially overlap the respective glue openings 127b in the lower row of glue openings in the back central panel 125b, the surface areas 129b in the lower row of surface areas on the back central panel 125b can extend along/at least partially overlap the respective glue openings 127a in the lower row of glue openings in the front central panel 125a, the surface areas 129a in the upper row of surface areas on the front central panel 125a can extend along/at least partially overlap the respective glue openings 127b in the upper row of glue openings in the back central panel 125b, and the surface areas 129b in the upper row of surface areas on the back central panel 125b can extend along/at least partially overlap the respective glue openings 127a in the upper row of glue openings in the front central panel 125a.

As schematically shown in FIG. 4, glue G1 applied along at least the surface areas 129b in the back central panel 125b can extend through respective glue openings 127a in the front central panel 125a to at least partially attach the back central panel 125b to the containers C in the front row R1 via the glue openings 127a in the front central panel 126a. Similarly, the glue G2 applied along at least the surface areas 129a in the front central panel 125a can extend through respective glue openings 127b in the back central panel 125b to at least partially attach the front central panel 125a to the containers C in the back row R2 via the glue openings 127b in the back central panel 125b.

The attachment of the containers C in the rows R2, R1 to the respective central panels 125a, 125b can provide retention and support of the respective containers, e.g., such that the containers do not detach from the carrier 105 under their own weight, in addition to or alternative to the container retention and support provided by the attachment of the containers C to the top panels 131a, 131b and/or the front and back panels 135a, 135b. In exemplary embodiments, the glue can be an aerated/foaming pressure sensitive adhesive that can facilitate full contact with uneven surfaces of the containers C and that can facilitate easy removal for consumers. In addition or alternatively, the glue G described herein can be, for example, a hot melt adhesive, a high tack glue, an epoxy, a polymeric cement, etc., or combinations thereof. Alternatively, any suitable glue could be used. The carrier 105 could be otherwise formed and attached to the containers C without departing from the disclosure. For example, the top panels 131a, 131b and/or the side panels 135a, 135b could be folded over and/or glued to the containers C before, during, and/or after forming the keel and/or attaching the keel to the containers C.

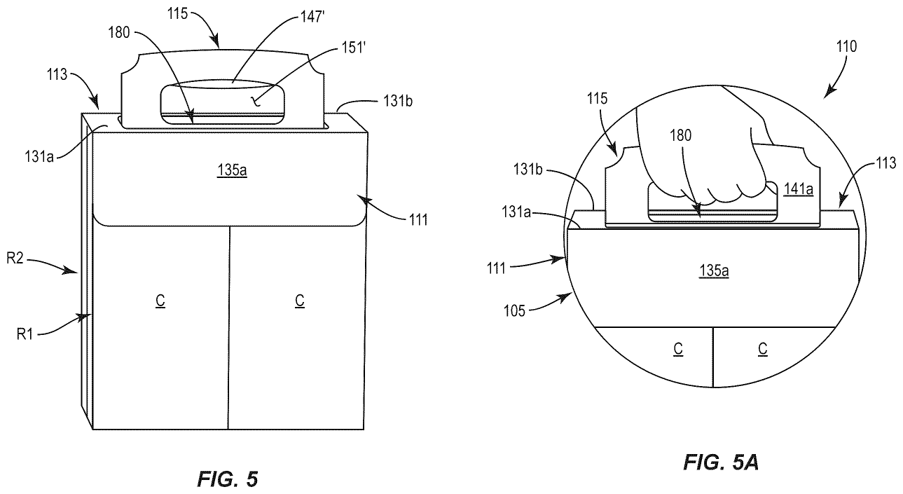

In one embodiment, the handle 115 of the carrier 105 includes handle panels 141a, 141b, each with a single handle opening 151′and a single handle flap 147′rather than the two handle openings 151 and two handle flaps 147 shown in the blank 103 of FIG. 1. As shown in FIGS. 5 and 5A, the handle 115 can be actuated for carrying the package 110 by folding the handle panels 141a, 141b upwardly relative to the top panels 131a, 131b along the respective fold lines 143a, 143b until the handle panels 141a, 141b are vertical and/or in face-to-face contact with one another. In embodiments, the first time the handle panels 141a, 141b are folded upwardly, out of the plane of the top panels 131a, 131b, the handle panels 141a, 141b can separate from the respective top panels 131a, 131b along the cut lines 145a, 145b, breaking the nicks that interrupt the cut lines 145a, 145b so that the handle panels 141a, 141b are free to pivot with respect to the top panels 131a, 131b. As shown in FIG. 5C, the actuated handle 115 can be used by grasping the upwardly folded and overlapped handle panels 141a, 141b. The handle 115 could be otherwise actuated and/or used without departing from the disclosure.

In embodiments, the containers C can be removed from the package 110 such as by pulling one or more of the containers C away from the carrier 105 to overcome the glue and/or by tearing the carrier 105 so that the container(s) C are detached from the carrier 105. The containers C could be otherwise removed from the package 110 without departing from the disclosure.

In exemplary embodiments, the carrier 105 can provide advantages over other packaging solutions, such as plastic shrink wrapping, wrap-style cartons, etc. For example, the package 110 allows the containers C to be removed individually from the carrier 105, while other containers C continue to be restrained by the carrier 105 (e.g., FIG. 3). In contrast, containers packaged with shrink wrapping are all released from the package when the shrink wrapping is removed. Further, the carrier 105 provides an improved printing surface (e.g., for labeling, advertising, etc.) compared to plastic shrink wrapping. For example, the front and back panels 135a, 135b can provide clear graphic real estate for ads, etc. Additionally, the carrier 105 can provide a sleek, unobtrusive profile, can take up minimal space, and can help reduce waste. Further, the carrier 105 provides easy access to the handle 115 for user convenience. As shown in FIGS. 2 and 3, the handle 115 can lay flat (e.g., coplanar with the top panels 131a, 131b) so that the package 110 is more easily included in multipacks and/or is otherwise stacked and/or arranged with other packages 110 and so that the package 110 provides a cleaner on-shelf presentation. In embodiments, only light pressure is used to actuate the handle 115 (e.g., to the lift the handle panels 141a, 141b away from the containers C) to provide a stable surface area for carrying the package 110. In embodiments, the carrier 105 and the blank 103 can be sized to fit a wide range of container sizes and/or any suitable number of containers. Further, the near symmetry of the blank 103 can facilitate efficient tessellating patterns of multiple blanks 103 in a web of packaging material (not shown). This can help improve and/or maximize sheet real estate (e.g., for printing) and can help limit waste when cutting the blanks 103 from the web. In exemplary embodiments, the carrier 105 can show a reduction in the weight of the packaging material (e.g., paperboard), such as when compared to wrap style cartons. For example, the carrier 105 can have an approximately 21-gram reduction in the packaging material (e.g., paperboard) weight and can have a 21% reduction in waste of the packaging material when cutting blanks 103 from a web of material.

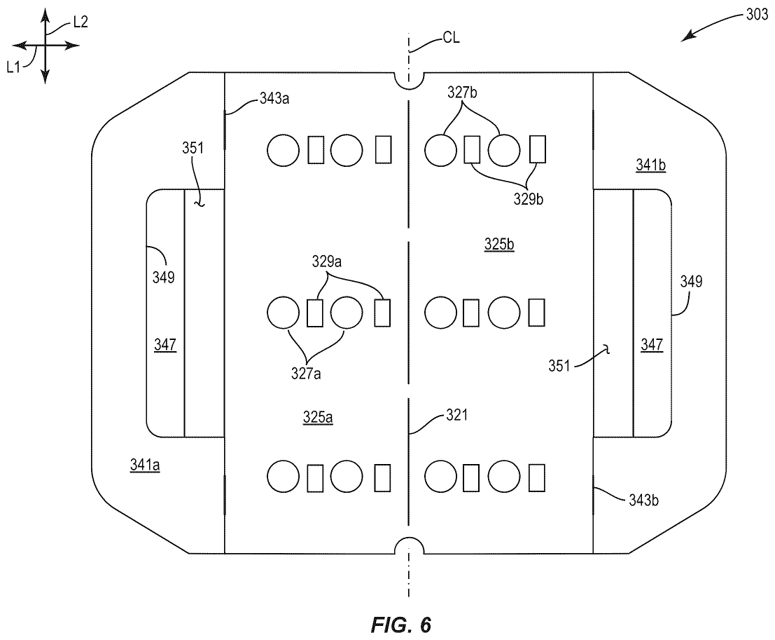

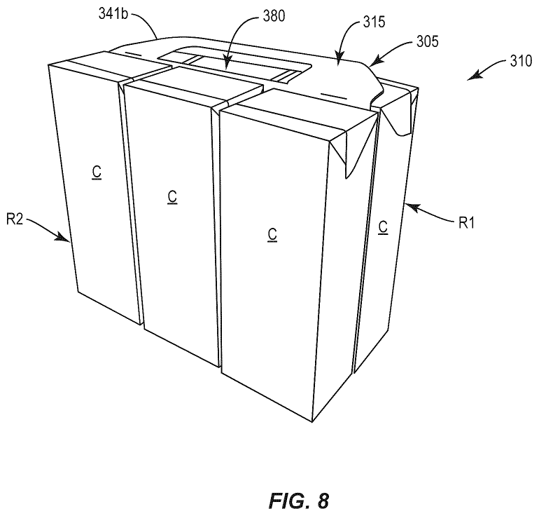

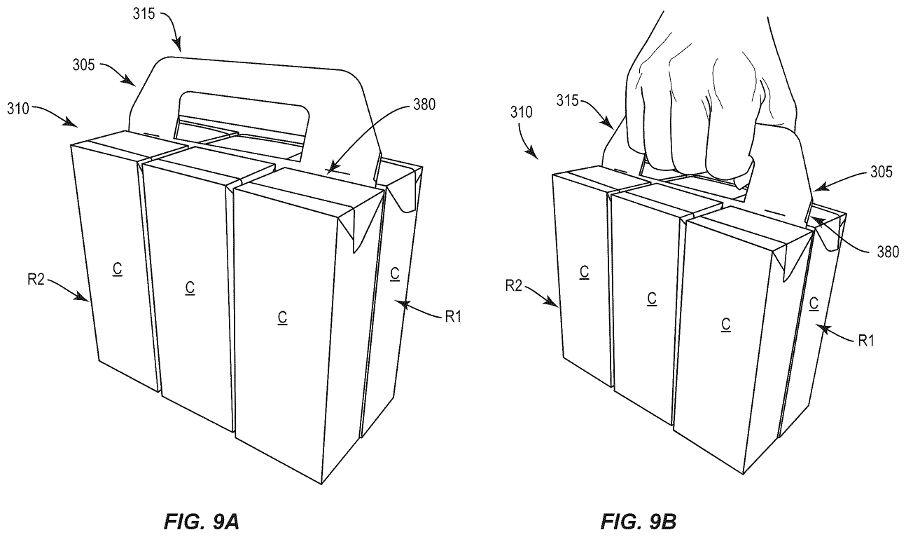

FIG. 6 is a plan view of a blank 303 for forming a carrier 305 engaging containers C to form a package 310 (FIGS. 8-9B) of a second embodiment of the disclosure. The second embodiment is generally similar to the prior embodiments, except for variations noted and variations that will be apparent to one of ordinary skill in the art. Accordingly, similar or identical features of the embodiments have been given like or similar reference numbers. In example embodiments, the blank 303 can be a 2-ply paperboard or any suitable paperboard or other suitable material. As shown in FIG. 6, the blank 303 includes a keel portion having a first/front central panel 325a foldably connected to a second/back central panel 325b along a central fold line 321. In the illustrated embodiments, the central panels 325a, 325b can be foldably connected to respective handle panels 341a, 341b along respective lateral fold lines 343a, 343b.

As shown in FIG. 6, the front central panel 325a can include a plurality of glue openings 327a and a plurality of surface areas 329a, and the back central panel 325b can include a plurality of glue openings 327b and a plurality of surface areas 329b. In embodiments, the glue openings 327a, 327b and the surface areas 329a, 329b can be similar to the glue openings 127a, 127b and the surface areas 129a, 129b of the blank 103 of FIG. 1. The keel portion, including any of the central panels 325a, 325b, the glue openings 327a, 327b, and/or the surface areas 329a, 329b, could be omitted or could be otherwise shaped, arranged, positioned, and/or configured without departing from the disclosure. Further, the glue openings 327a, 327b and surface areas 329a, 329b can be positioned on the central panels 325a, 325b to have similar or identical dimensions D1a, D2a, D3a, D4a and D1b, D2b, D3b, D4b as the blank 103 as the first embodiment.

In the illustrated embodiments, the handle features can include handle flaps 347 foldably connected to the respective handle panels 341a, 341b along respective lateral fold lines 349. As shown in FIG. 6, the handle flaps 347 can extend along respective handle openings 351. Any of the handle features, including any of the handle panels 341a, 341b, the handle flaps 347, and/or the handle openings 351, could be omitted or could be otherwise shaped, arranged, positioned, and/or configured without departing from the disclosure.

The blank 303 could be otherwise shaped, arranged, and/or configured without departing from the disclosure.

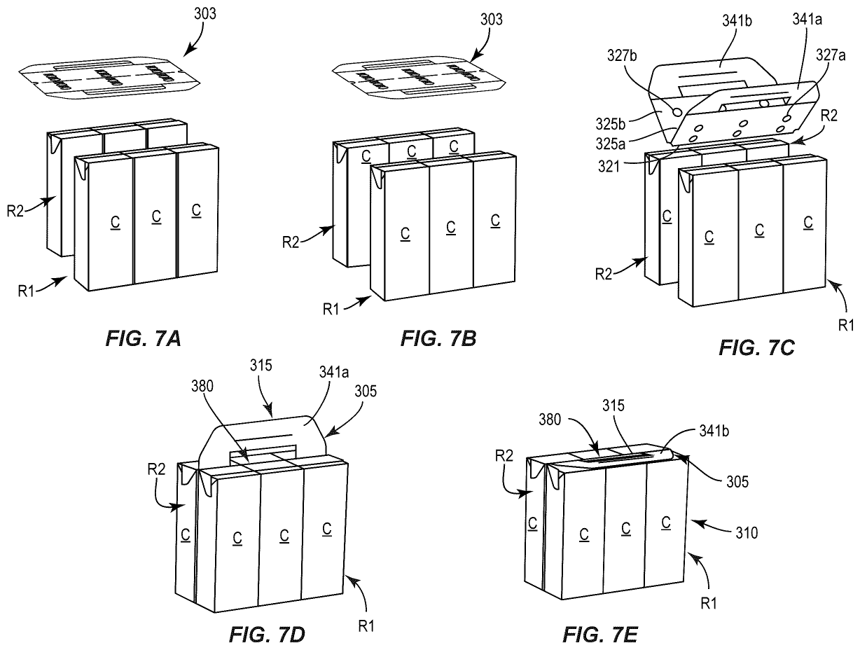

As shown in FIGS. 7A-7D, the blank 303 can be folded and attached to the containers C. For example, the blank 303 can be aligned with the rows R1, R2 of the containers C (FIG. 7A), e.g., while moving the containers C and the blank 303 in a downstream direction on a conveyor. In exemplary embodiments, the containers C can be arranged in two rows R1, R2 of three containers C, each. Alternatively, any suitable number of the containers C could be provided in any suitable arrangement. Glue can be applied to the blank 303 along at least a portion of one or both of the handle panels 341a, 341b and along at least a portion of the central panels 325a, 325b (FIG. 7B), e.g., along at least the surface areas 329a, 329b of the central panels 325a, 325b, before, during, and/or after aligning the blank 303 with the containers C. As shown in FIG. 7C, the blank 303 can be folded along the central fold line 321, bring the central panels 325a, 325b together in an overlapping relationship and/or in face-to-face contact, while moving the central panels 325a, 325b between the rows R1, R2 of containers C and moving the rows R1, R2 together. In embodiments, the overlapped central panels 325a, 325b can form the keel 380 extending between the rows R1, R2 of the containers C, and the overlapped handle panels 341a, 341b can form the handle 315 extending upwardly from the keel 380 (FIG. 7D). The keel 380 of the carrier 305 can be attached to the front row R1 of containers C and the back row R2 of containers C in a similar manner as the keel 180 of the carrier 105 of the first embodiment. That is, the front central panel 325a can be attached to the back row R2 of containers C by way of the glue openings 327b in the back central panel 325b and the back central panel 325b can be attached to the front row R1 of containers C by way of the glue openings 327a in the front central panel 325a. The positioning and configuration of the glue openings 327a, 327b facilitate attachment of the containers C to the keel 380.

In exemplary embodiments, glue can be applied to an exterior surface of the handle panel 341a and/or to the top of one or more of the containers C in the first row R1, and the handle 315 can be folded over the tops of the containers C in the first row R1 to glue the handle down against the tops of the containers C (FIG. 7E). Alternatively, the handle 315 can be folded downwardly and glued to the tops of the containers C in the second row R2. In embodiments, the package 310 shown in FIGS. 7E and 8 with the handle 315 in the folded downward position can be stacked and/or packed efficiently for storage, shipping, and/or display.

As shown in FIGS. 9A and 9B, the handle 315 can be actuated by pulling the handle 315 upwardly (e.g., breaking the bond provided by the glue to separate the handle from the tops of the containers C). In embodiments, the handle 315 can be folded to a vertical position, extending upwardly from the keel 380 and from the tops of the containers C.

In embodiments, one or more of the containers C can be removed from the package 310 by pulling the container(s) C away from the carrier 305 to break the bond of the glue attaching the container(s) C to the keel and to separate the container(s) C from the carrier 305.

Any of the features of the various embodiments of the disclosure can be combined with, replaced by, or otherwise configured with other features of other embodiments of the disclosure without departing from the scope of this disclosure.

In general, the blanks according to the present disclosure can be constructed from paperboard having a caliper so that it is heavier and more rigid than ordinary paper. The blanks can also be constructed of other materials, such as cardboard, or any other material having properties suitable for enabling the carton to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

Additionally, spatially relative terms, such as “bottom or “top”; or “front” or “back”; and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” “exemplary embodiments”, or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” “in some embodiments”, or other like phrases in various places throughout this specification are not necessarily all referring to the same feature, example, and/or limitation. Furthermore, the particular features, structures, or characteristics may be combined in one or more examples and/or features.

What is claimed is:

1. A carrier for holding a plurality of containers, the carrier comprising:
a front central panel, a back central panel foldably connected to the front central panel, the front central panel and the back central panel for being attached to at least one container of the plurality of containers; and
handle features foldably connected to the front central panel and the back central panel, the handle features comprising a front handle panel foldably connected to the front central panel and a back handle panel foldably connected to the back central panel, the front handle panel and the back handle panel forming a handle of the carrier,
the front central panel comprises at least one front glue opening and the back central panel comprises at least one back glue opening.

2. The carrier of claim 1, wherein a surface of the front central panel is for being adhered to a back container of adjacent containers and a surface of the back central panel is for being adhered to a front container of the adjacent containers.

3. The carrier of claim 1, wherein the front central panel is foldably connected to the back central panel at a fold line.

4. The carrier of claim 3, wherein the front central panel is in at least partial face-to-face contact with the back central panel such that a portion of the back central panel is exposed through the at least one front glue opening and a portion of the front central panel is exposed through the at least one back glue opening.

5. The carrier of claim 4, wherein the at least one front glue opening is a plurality of front glue openings and the at least one back glue opening is a plurality of back glue openings, the plurality of front glue openings are in communication with the back central panel and the plurality of back glue openings are in communication with the front central panel.

6. The carrier of claim 5, the plurality of front glue openings comprises a first row of front glue openings and a second row of front glue openings spaced apart from the first row of front glue openings.

7. The carrier of claim 6, the first row of front glue openings is spaced a first distance from the fold line, and the second row of front glue openings is spaced a second distance from the fold line, the second distance is greater than the first distance.

8. The carrier of claim 7, wherein the plurality of back glue openings comprises a first row of back glue openings and a second row of back glue openings spaced apart from the first row of back glue openings, the first row of back glue openings is spaced a third distance from the fold line, and the second row of back glue openings is spaced a fourth distance from the fold line, the fourth distance is greater than the third distance.

9. The carrier of claim 8, wherein the front central panel and the back central panel are in contact such that a respective portion of the back central panel is exposed through the plurality of front glue openings and a respective portion of the front central panel is exposed through the plurality of back glue openings, the respective portion of the front central panel and the respective portion of the back central panel are for receiving an adhesive.

10. The carrier of claim 1, wherein the first handle panel and the second handle panel are in face-to-face contact to form the handle.

11. The carrier of claim 10, further comprising a front top panel foldably connected to the front central panel and a back top panel foldably connected to the back top panel.

12. The carrier of claim 11, wherein the front handle panel is defined by a tear line in the front top panel and the back handle panel is defined by a tear line in the back top panel.

13. The carrier of claim 11, further comprising a front panel foldably connected to the front top panel and a back panel foldably connected to the back top panel.

14. A blank for holding a plurality of containers, the blank comprising:
a front central panel, a back central panel foldably connected to the front central panel, the front central panel and the back central panel are for being attached to at least one container of the plurality of containers in the carrier formed from the blank; and
handle features foldably connected to the front central panel and the back central panel, the handle features comprising a front handle panel foldably connected to the front central panel and a back handle panel foldably connected to the back central panel, the front handle panel and the back handle panel forming a handle of the carrier formed from the blank,
the front central panel comprises at least one front glue opening and the back central panel comprises at least one back glue opening.

15. The blank of claim 14, wherein the front central panel is foldably connected to the back central panel at a fold line.

16. The blank of claim 15, wherein the front central panel is for being in at least partial face-to-face contact with the back central panel such that a portion of the back central panel is exposed through the at least one front glue opening and a portion of the front central panel is exposed through the at least one back glue opening in the carrier formed from the blank.

17. The blank of claim 16, the at least one front glue opening is a plurality of front glue openings and the at least one back glue opening is a plurality of back glue openings, the plurality of front glue openings comprises a first row of front glue openings and a second row of front glue openings spaced apart from the first row of front glue openings.

18. The blank of claim 17, the first row of front glue openings is spaced a first distance from the fold line, and the second row of front glue openings is spaced a second distance from the fold line, the second distance is greater than the first distance.

19. The blank of claim 18, wherein the plurality of back glue openings comprises a first row of back glue openings and a second row of back glue openings spaced apart from the first row of back glue openings, the first row of back glue openings is spaced a third distance from the fold line, and the second row of back glue openings is spaced a fourth distance from the fold line, the fourth distance is greater than the third distance.

20. The blank of claim 19, wherein the front central panel and the back central panel are for being in contact such that a respective portion of the back central panel is exposed through the plurality of front glue openings and a respective portion of the front central panel is exposed through the plurality of back glue openings in the carrier formed from the blank, the respective portion of the front central panel and the respective portion of the back central panel are for receiving an adhesive.

21. The blank of claim 14, further comprising a front top panel foldably connected to the front central panel and a back top panel foldably connected to the back top panel.

22. The blank of claim 21, wherein the front handle panel is defined by a tear line in the front top panel and the back handle panel is defined by a tear line in the back top panel.

23. The blank of claim 21, further comprising a front panel foldably connected to the front top panel and a back panel foldably connected to the back top panel.

24. A method of forming carrier for holding a plurality of containers, the method comprising:
obtaining a blank comprising a front central panel, a back central panel foldably connected to the front central panel, the front central panel comprises at least one front glue opening and the back central panel comprises at least one back glue opening, handle features foldably connected to the front central panel and the back central panel, the handle features comprising a front handle panel foldably connected to the front central panel and a back handle panel foldably connected to the back central panel;
attaching the front central panel and the back central panel to at least one container of the plurality of containers;
forming a handle from the front handle panel and the back handle panel.

25. The method of claim 24, wherein the attaching comprises adhering a surface of the front central panel to a back container of adjacent containers and adhering a surface of the back central panel to a front container of the adjacent containers.

26. The method of claim 25, wherein the front central panel is foldably connected to the back central panel at a fold line, and the method comprises positioning the front central panel in at least partial face-to-face contact with the back central panel such that a portion of the back central panel is exposed through the at least one front glue opening and a portion of the front central panel is exposed through the at least one back glue opening.

27. The method of claim 26, wherein the at least one front glue opening is a plurality of front glue openings and the at least one back glue opening is a plurality of back glue openings, the plurality of front glue openings are in communication with the back central panel and the plurality of back glue openings are in communication with the front central panel.

28. The method of claim 27, the plurality of front glue openings comprises a first row of front glue openings and a second row of front glue openings spaced apart from the first row of front glue openings.

29. The method of claim 28, the first row of front glue openings is spaced a first distance from the fold line, and the second row of front glue openings is spaced a second distance from the fold line, the second distance is greater than the first distance.

30. The method of claim 29, wherein the plurality of back glue openings comprises a first row of back glue openings and a second row of back glue openings spaced apart from the first row of back glue openings, the first row of back glue openings is spaced a third distance from the fold line, and the second row of back glue openings is spaced a fourth distance from the fold line, the fourth distance is greater than the third distance.

31. The method of claim 30, wherein the front central panel and the back central panel are in contact such that a respective portion of the back central panel is exposed through the plurality of front glue openings and a respective portion of the front central panel is exposed through the plurality of back glue openings, the respective portion of the front central panel and the respective portion of the back central panel are for receiving an adhesive.

32. The method of claim 24, wherein the forming the handle comprises positioning the first handle panel and the second handle panel in face-to-face contact.

33. The method of claim 32, wherein the blank further comprises a front top panel foldably connected to the front central panel and a back top panel foldably connected to the back top panel, the front handle panel is defined by a tear line in the front top panel and the back handle panel is defined by a tear line in the back top panel.

34. The method of claim 33, the blank comprises a front panel foldably connected to the front top panel and a back panel foldably connected to the back top panel, the method comprises downwardly folding the front panel relative to the front panel and downwardly folding the back panel relative to the back top panel.

35. A package comprising:
a plurality of containers; and
a carrier as set forth in claim 1 holding the plurality of containers.
